(19) United States
(12) Patent Application Publication
(10) Pub. No.: US 2017/0156986 A1
(43) Pub. Date: Jun. 8, 2017

(54) Pill Bottle Labeling System

(71) Applicant: Eugene W. Campbell, Parker, CO (US)

(72) Inventor: Eugene W. Campbell, Parker, CO (US)

(21) Appl. No.: 14/961,385

(22) Filed: Dec. 7, 2015

(51) Int. Cl. A61J 7/04; B65D 25/10; B65D 51/24; A61J 1/03; B65D 25/20

(52) U.S. Cl. CPC A61J 7/04; A61J 1/03; B65D 25/205; B65D 51/245; B65D 25/10; A61J 2205/50

(57) ABSTRACT

A pill bottle labeling system having a pill bottle, open top housing. The housing is used for holding a plurality of pill bottles with bottle caps. The system includes a plurality of bottle cap labels with an adhesive backing. The bottle cap labels having different drug names and vitamin supplement names printed thereon. The bottle cap labels are attached to a top of the bottle caps. The labels provide quick identification of a pill from a selected bottle. Also, the labeling system includes a time of day and night labels with an adhesive backing. The time of day and night labels are attached to a side of the pill bottles. The time of day and night labels provide for identifying a time of day or night when the pill is to be taken.

This non-provisional patent application claims the benefit for an earlier filed provisional patent application, Ser. No. 62/088,760, filed on Dec. 8, 2014, by the subject inventor, having a title of “Prescription and Vitamin Pill Bottle Organizer Kit”. Also, this application claims the benefit of the subject matter found in the earlier filed provisional patent application.

### BACKGROUND OF THE INVENTION

(a) Field of the Invention

This invention relates to organizing pill bottles, and more particularly but not by way of limitation, to a labeling system and method for organizing pill bottles with large print generic labels for ease in identifying and taking a correct pill at a selected time, particularly for elderly senior citizens, sight impaired citizens, and the handicap, who might have trouble identifying one prescription medicine from another.

(b) Discussion of Prior Art

Heretofore, there have been a large number of issued patents related to different types of pill box containers, dispensing boxes, medication organizing systems and pill box. None of these prior art patents disclose the unique structure and function of the subject pill bottle labeling system as disclosed herein.

### SUMMARY OF THE INVENTION

In view of the foregoing, it is a primary objective of the subject invention to provide a pill bottle labeling system that provides large print generic labels on top of pill bottles which can be easily identified by a user of the labeling system, particularly by elderly citizens. The generic labels are used to identify both prescription drugs and vitamin supplements.

Still another object of the invention is the labeling system contains a pill bottle, open top housing for holding any number of pill bottles, thus eliminating the need to store individual bottles kept in plastic bags, or in kitchen and bathroom drawers.

Yet another object of the invention is the use of clear “pop-top” caps on the pill bottles for quick access to pills inside the bottles and eliminating the use of difficult to open opaque prescription bottles.

These and other objects of the present invention will become apparent to those familiar with different types of pill bottle organizing systems when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### DESCRIPTION OF THE DRAWINGS

The accompanying drawings illustrate complete preferred embodiments in the present invention according to the best modes presently devised for the practical application of the subject pill organizer kit, and in which:

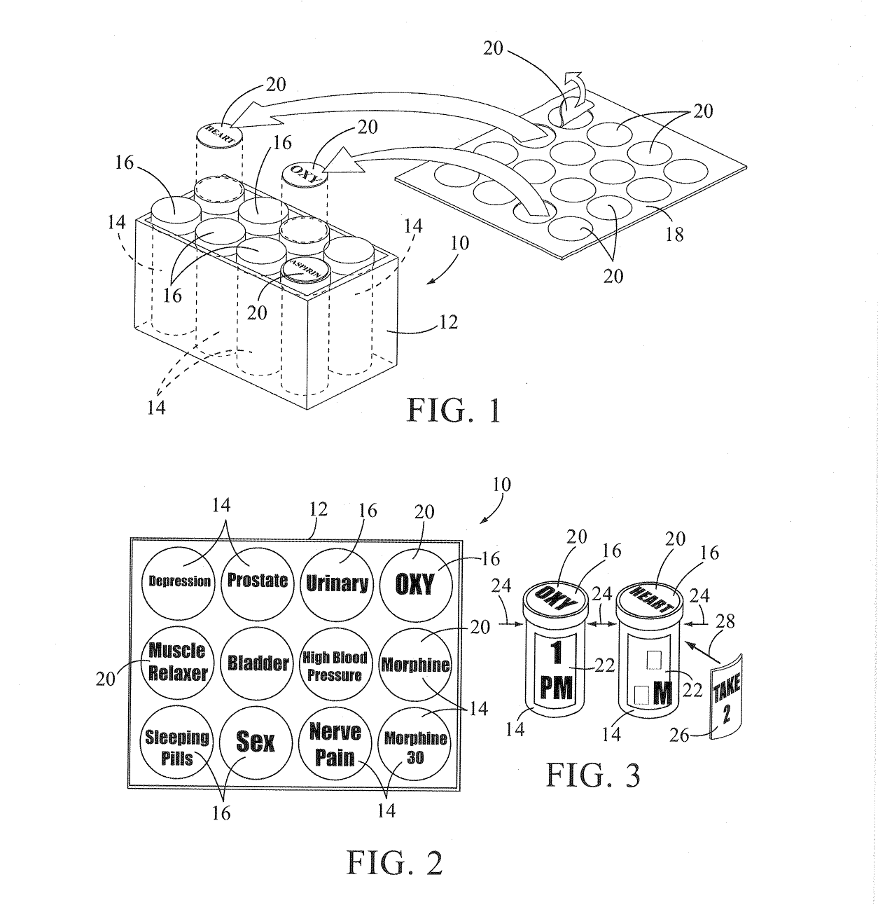

In FIG. 1, a perspective view of the pill bottle labeling system is shown and having general reference numeral 10. The system 10 includes an open top housing 12 for holding a plurality of individual pill bottles 14 with bottle caps 16. In this drawing, eight pill bottles 14 are shown nested inside the housing 12.

The invention is characterized by using a paper sheet 18 having a plurality of generic labels 20 printed thereon and with an adhesive backing for attaching the labels to the bottle caps or sides of the pill bottles. The labels 20 can identify any number of prescription drugs by a drug company's brand name, or a generic name for the medicine, and vitamin names. In this example, a label 20 having a generic term “OXY” is shown being transferred for attaching to the top of one of the caps 16 on one of the pill bottles 14 in the housing 12. Another label 20, identified as “HEART”, is shown being transferred for attaching to the top of the cap 16 of another pill bottle 14.

In FIG. 2, a top view of the open top housing 12 is shown holding twelve pill bottles 14 stored therein and having different generic labels 20 attached to the top of the caps 16 for quick identification of a prescription drug to be taken.

In FIG. 3, a perspective view of two of the pill bottles 14 are shown with large print, time of day and night labels 22 shown attached to the side of the bottles. One of the bottles 14 illustrates a drug “OXY” to be taken at 1 pm in the afternoon. The 1 pm can be printed on a label 22. Another bottle 14 illustrates a drug “HEART” to be taken. This label 22 can be blank as to the number of pills to be taken and as to the time of day or night left blank. The two blank lines can be completed by a pill taker or care provider.

By using a combination of large print, generic labels 20 and time of day and night labels 22, a user of the system 10 is better organized to take the correct pill at a selected time for improved health and safety. A paper sheet, similar to sheet 18, can be printed including different times of day and night for attaching to the sides of the bottles 14. Also, a paper sheet, similar to sheet 18, can be printed to include “Take 1” or “Take 2” labels. In this drawing, a label 26 is shown and marked “Take 2”, to indentify the number of pills to be taken at a given time. The label 26 is shown ready for attachment, as indicated by arrow 28, to a side of one of the bottles 14.

Also shown in FIG. 3 are arrows 24 on opposite sides of the top of the pill bottles 14. By pressing inwardly, as shown by the arrows 24, the caps 16 are quickly released from the top of the bottle 14 for easy access to the pills inside.

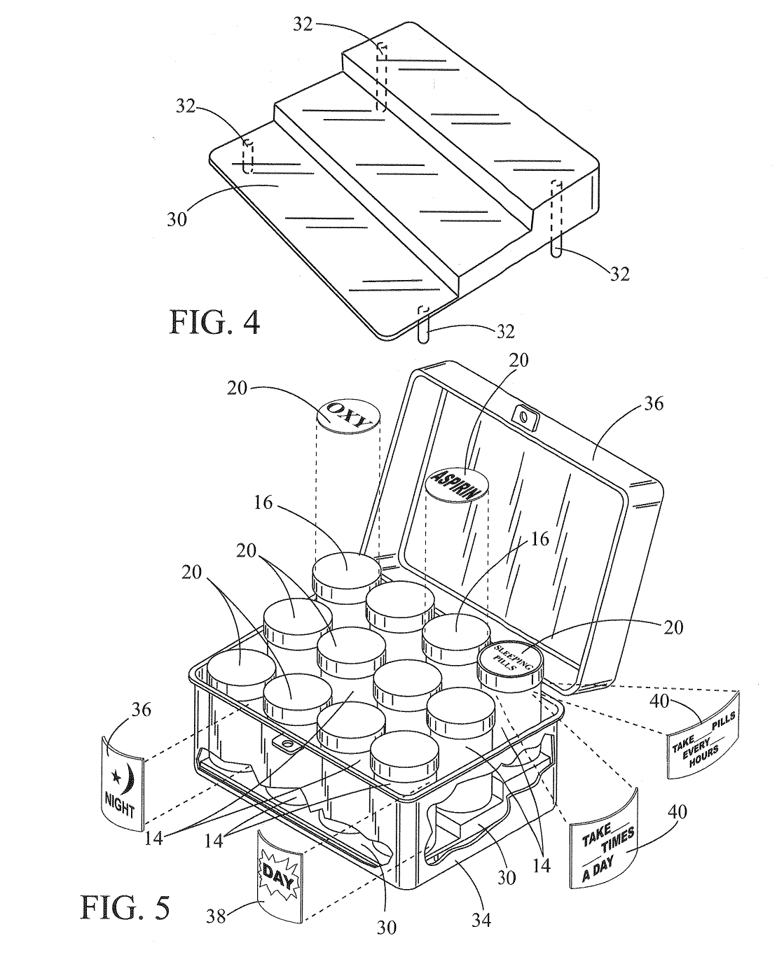

In FIG. 4, a stair stepped stand 30 is shown having posts 32 attached to a bottom of the stand. The stand 30 is designed to hold the pill bottles 14 inside an open top housing at three different levels, as shown in FIG. 5, for easy access and bottle identification. Obviously, the stand 30 can be made for different size housings and two or more stair steps for holding the pill bottles at different heights.

In FIG. 5, a large open top housing 34 is shown with a lid 36. A portion of the sides of the housing 34 are cut away to illustrate the bottles 14 held on the stand 30 at different heights inside the housing for easy access and pill bottle identification. In this drawing, labels 20 for “OXY” and “ASPIRIN” are shown attached to two of the pill bottle caps 16. To help enhance taking of pills at night and during the day, a label 36, indicating “Night” time, having a moon and star, can be attached to the side of one of the bottles for night time use. Further, a label 38 indicating “Day” time, having a shining sun, can be used equally well for day time use. In this drawing, a Take ______, Times A Day label 40 is shown with a blank line filing in the number of pills to be taken and the number of times a day or night to be filled in. Also, a similar label 40 is shown with Take ______ Pills Every ______ hours to be completed by the user of the pill labeling system or a caregiver.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which an exclusive privilege and property right is claimed are defined as follows:

1. A pill bottle labeling system, the system comprising:
a pill bottle, open top housing, the housing for holding a plurality of pill bottles with bottle caps; and
a plurality of bottle cap labels with an adhesive backing, the bottle cap labels having different drug names and vitamin supplement names printed thereon, the bottle cap labels attached to the top of the bottle caps, the labels providing quick identification for a selected bottle.

2. The labeling system as described in claim 1 further including a time of day and night labels with an adhesive backing, the time of day and night labels attached to the side of the pill bottles, the time of day and night labels provide for the time of day or night when a selected pill is to be taken.

3. The labeling system as described in claim 1 further including labels indicating the number of pills to be taken at a given time, the labels attached to the sides of the pill bottles.

4. The labeling system as described in claim 1 having labels with a blank line for filing in a time of day or night to take a pill.

5. The labeling system as described in claim 4 having labels with a blank line for filing in a number of bills to be taken at a selected time of day or night.

6. The labeling system as described in claim 1 further including a stair stepped stand dimensioned for receipt inside the open top housing, the stair stepped stand holding the pill bottles as different heights inside the open top housing.

7. A pill bottle labeling system, the system comprising:
a pill bottle, open top housing, the housing for holding a plurality of pill bottles with bottle caps;
a plurality of bottle cap labels with an adhesive backing, the bottle cap labels having different drug names and vitamin supplement names printed thereon, the bottle cap labels attached to the top of the bottle caps, the labels providing quick identification for a selected bottle; and
time of day and night labels with a blank line for completing a selected time of day or night to take a selected pill thereon and a blank line for completing a number of pills to be taken at the selected time, the day and night labels having an adhesive backing, the time of day and night labels attached to the side of the pill bottles.

8. The labeling system as described in claim 7 further including a stair stepped stand, having at least 2 steps, the stand dimensioned for receipt inside the open top housing, the stair stepped stand holding the pill bottles at different heights inside the open top housing.

9. The labeling system as described in claim 7 further including a lid for covering the open top housing with pill bottles stored therein.

10. A pill bottle labeling system, the system comprising:
a pill bottle, open top housing with lid, the housing for holding a plurality of pill bottles with quick release, bottle caps;
a plurality of large print, bottle cap labels with an adhesive backing, the bottle cap labels having different drug names and vitamin supplement names printed thereon, the bottle cap labels attached to the top of the bottle caps, the labels providing quick identification for a selected bottle;
time of day and night labels with a blank line, the blank line for completing a selected time of day or night to take a selected pill thereon, the time of day and night labels also having a blank line for completing a number of pills to be taken at the selected time, the day and night labels having an adhesive backing, the time of day and night labels attached to the side of the pill bottles; and
a stair stepped stand, having at least 2 steps, the stand dimensioned for receipt inside the open top housing, the stair stepped stand holding the pill bottles at different heights inside the open top housing.

11. The labeling system as described in claim 10 further including night time labels with a moon and a star, the night time labels used to enhance the pill bottle for taking pills at night.

12. The labeling system as described in claim 10 further including day time labels with a shining sun, the day time labels used to enhance the pill bottle for taking pills during the day.
